(19) United States
(12) Patent Application Publication
(10) Pub. No.: US 2025/0143300 A1
(43) Pub. Date: May 8, 2025

(54) Composition for the Treatment of Plant Parasitic Nematodes

(71) Applicant: Jeneil Biosurfactant Company, LLC, Saukville, WI (US)

(72) Inventors: Erika Consoli, Bozeman, MT (US); Alan T. Dyer, Bozeman, MT (US); Gary A. Strobel, Bozeman, MT (US)

(21) Appl. No.: 19/003,784

(22) Filed: Dec. 27, 2024

Related U.S. Application Data
(63) Continuation of application No. PCT/US2023/026751, filed on Jun. 30, 2023.
(60) Provisional application No. 63/357,313, filed on Jun. 30, 2022.

(51) Int. Cl. A01N 37/02; A01N 25/02; A01N 35/04; A01P 5/00

(52) U.S. Cl. CPC A01N 37/02; A01N 25/02; A01N 35/04; A01P 5/00

(57) ABSTRACT

Embodiments of the disclosure relate to a nematicidal composition. The composition includes propanoic acid, a salt of a C₄-C₆ acid, an acid ester of a C₂-C₅ carboxylic acid moiety and a C₂-C₅ alcohol moiety, and a C₂-C₈ aldehyde. A ratio of the propanoic acid to the salt to the acid ester to the C₂-C₈ aldehyde is 2:2:5:2 (v/v/w/v). Embodiments of the disclosure also relate to a method of treating plant parasitic nematodes. In the method, a solution including the composition is applied to soil surrounding the plant.

### CROSS-REFERENCE TO RELATED PATENT APPLICATIONS

This application is a continuation of International Application No. PCT/US2023/026751, filed on Jun. 30, 2023, which claims priority to U.S. Provisional Application No. 63/357,313, filed Jun. 30, 2022, both of which are incorporated herein by reference in their entireties.

### FIELD OF THE INVENTION

This invention generally relates to a composition for the treatment of nematodes and, in particular, to an environmentally-friendly composition for the treatment of plant parasitic nematodes.

### BACKGROUND OF THE INVENTION

The annual global loss in agriculture due to damage by plant-parasitic nematodes has been estimated as $100 billion worldwide. These parasitic nematodes are obligate parasites, which need live plants for their development and reproduction. Nematode damage to plants may not always be recognized since these agents of disease reside below ground, and symptoms of nematode attack are often mistaken for nutritional deficiency or secondary plant pathogens. Most plant-parasitic nematodes attack the roots or other parts of the plants in the soil, such as bulbs and tubers, and these attacks interrupt the uptake of water and nutrients by plants. Plants infected with nematodes usually show symptoms resembling those of water or nutrition deficiency. In particular, infected plants may appear small, chlorotic, and less vigorous. However, some nematodes can infect upper plant parts, causing significant economic damage for crop plants, such as the case of Anguina spp. and Aphelenchoides spp. In addition to such direct damage to plants, some nematodes may transmit plant viruses. Further, other pathogens, such as fungi and bacteria, may easily invade plants through injuries and a weakened plant immune system caused by nematodes. In addition, breakdown of plant resistance to fungal pathogens due to nematode infection has been reported. Thus, parasitic nematodes can have a dual role in causing disease effects in plants.

The three most economically important nematodes in the agriculture worldwide are root-knot (Meloidogyne spp.), cyst nematodes (Heterodera spp. and Globodera spp.), and root lesion nematodes. Root-knot and root-lesion nematodes are polyphagous, i.e., each species can infect a great number of plant species, from grasses to trees, typically causing root galls or lesions, respectively. For this reason, effective control of root-knot nematodes by crop rotation is very limited. In contrast to root-knot nematodes, cyst nematodes are generally host-specific parasites and can effectively be controlled by crop rotation with non-host plants. Several species of cyst nematode cause great damage to potato (potato cyst nematode, Globodera spp.), soybean (soybean cyst nematode, Heterodera glycines), cereals (cereal cyst nematodes, Heterodera spp. and Cactodera spp), and beet (beet cyst nematodes, Heterodera spp.), if appropriate control measures are not taken.

Today, plant-parasitic nematodes are mostly controlled by chemical nematicides, cultural practices, and the growing of resistant cultivars. However, the major chemical fumigant nematicides are slated for reduction due to potential environmental problems as well as human and animal health concerns. For example, effective nematicides such as DBCP (dibromochloropropane) and EDB (ethylene dibromide) have been withdrawn from the market due to their possible deleterious effects on humans and the environment. Methyl bromide, the most effective and widely used fumigant for soil-borne diseases and weeds, including nematodes, has already been banned in some countries, and its complete withdrawal from the market is planned for most countries by international agreements. However, the use of non-fumigant nematicides based on organophosphates and carbamates is expected to increase following the withdrawal of methyl bromide, but this has resulted in new environmental concerns since these agents are highly toxic. For instance, toxic aldicarb, which is used to control insects and nematodes, has been detected in groundwater. Also, high levels of 1,3-dichloropropene (1,3-D), the last general-use soil fumigant, have been detected in the air of California, where this nematicide is used intensively. Under such circumstances, the role of integrated pest management (IPM), which consists of conventional and new control strategies, has become important as alternatives to the use of such chemicals in the control of parasitic nematodes.

Although there are many products listed for the control of plant parasitic nematodes, few are considered effective and commercially useful. This is because some can harm plants, and others, relying upon biological control features of the product, may not function because of environmental limitations that effect the ideal performance of the agent. Basically, novel and environmental-friendly nematicides are urgently needed because of the harmful effects of some existing nematicides on human health and the environment. Presently, chemical nematicides that claim to be environmentally friendly, such as garlic extracts and some biological agents, have proven to be ineffective. Thus, Applicant has identified a need for the discovery, approval, and marketing of novel, safe, and effective nematicidal agents for use in modern agriculture worldwide.

### BRIEF SUMMARY OF THE INVENTION

Embodiments of the presently disclosed invention address the foregoing problems and issues. These and other advantages of the invention, as well as additional inventive features, will be apparent from the description of the invention provided herein.

According to an aspect, embodiments of the disclosure relate to a nematicidal composition. The composition includes propanoic acid, a salt of a C₄-C₆ acid, an acid ester of a C₂-C₅ carboxylic acid moiety and a C₂-C₅ alcohol moiety, and a C₂-C₈ aldehyde. A ratio of the propanoic acid to the salt to the acid ester to the C₂-C₈ aldehyde is 2:2:5:2 (v/v/w/v).

According to another aspect, embodiments of the disclosure relate to a nematicidal composition. The nematicidal composition includes a liquid component including propanoic acid, at least one acid ester, and at least one aldehyde. The propanoic acid, the at least one acid ester, and the at least one aldehyde make up from 90% to 100% by volume of the liquid component. The nematicidal composition also includes an acid salt dissolved in the liquid component.

According to a further aspect, embodiments of the disclosure relate to a method of treating plant parasitic nematodes. In the method, a solution including a composition is applied to soil surrounding a plant. The composition is made up of propanoic acid, a salt of a C₄-C₆ acid, an acid ester of a C₂-C₅ carboxylic acid moiety and a C₂-C₅ alcohol moiety, and a C₂-C₈ aldehyde. A ratio of the propanoic acid to the salt to the acid ester to the C₂-C₈ aldehyde is 2:2:5:2 (v/v/w/v).

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 depicts a graph of nematode mortality as a function of a concentration of nematicidal composition for various times, according to embodiments of the present disclosure;

FIGS. 2A-2C depict root-knot nematode appearances after 30 hours of exposure to a water control (FIG. 2A) and to a 1% solution of a nematicidal composition according to an embodiment of the present disclosure (FIGS. 2B and 2C);

FIGS. 3A-3C depict root-lesion nematode appearances after 4 hours of exposure to a water control (FIG. 3A) and to a 0.5% solution of a nematicidal solution according to an embodiment of the present disclosure (FIGS. 3B and 3C); and

FIG. 4 depicts a graph reflecting the effect of various concentrations of a nematicidal composition on root-lesion nematodes, according to embodiments of the present disclosure.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Various embodiments of the present disclosure relate to a composition particularly suitable for the treatment of plant-parasitic nematodes. In embodiments, the composition includes propanoic acid, an acid ester, an acid salt, and an aldehyde. In particular embodiments, the acid ester is an ester of a C₂-C₅ carboxylic acid and a C₂-C₅ alcohol, such as isobutyl isobutyrate. In particular embodiments, the acid salt is a salt of a C₄-C₆ acid, such as a potassium, sodium, or ammonium salt (e.g., potassium isobutyrate). In particular embodiments, the aldehyde is a C₂-C₈ aldehyde, such as benzaldehyde. In one or more of the foregoing embodiments, the ratio of propanoic acid to acid ester to acid salt to aldehyde is 2:2:5:2 (v/v/w/v). A composition as described may be diluted with water to a 1% solution and applied directly to plants or in the soil surrounding plants to treat or prevent plant-parasitic nematode infections. Advantageously, such a composition is environmentally friendly and effective, especially compared to conventional nematicides. These and other aspects and advantages will be described in greater detail below and in relation to the accompanying figures. The embodiments described herein should be considered illustrative, and not limiting.

As mentioned, compositions of the present disclosure provide an effective and environmentally-friendly nematicide. In embodiments, the composition includes propanoic acid, an acid ester, an acid salt, and an aldehyde.

In one or more embodiments, the acid salt is a salt of a C₄-C₆ acid. In one or more embodiments, the C₄-C₆ acid comprises at least one C₄ acid, such as butyric acid and/or isobutyric acid. In one or more embodiments, the C₄-C₆ acid comprises at least one C₅ acid, such as valeric acid, isovaleric acid, 2-methylbutanoic acid, and/or pivalic acid. In one or more embodiments, the C₄-C₆ acid comprises a C₆ acid, such as hexanoic acid, citric acid, and/or sorbic acid. In one or more embodiments, the acid salt is formed with a cation of sodium, potassium, or ammonium. In a particular embodiment, the acid salt comprises potassium isobutyrate.

In one or more embodiments, the moieties of the acid ester can be described as having a C₂-C₅ carboxylic acid moiety and a C₂-C₅ alcohol moiety. In one or more embodiments, the C₂-C₅ acid moiety comprises at least one of acetic acid, propanoic acid, butyric acid, isobutyric acid, valeric acid, and isovaleric acid. In one or more embodiments, the C₂-C₅ alcohol moiety comprises at least one of ethanol, propanol, allyl alcohol, isopropanol, butanol, isobutanol, sec-butanol, tert-butanol, pentanol, isoamyl alcohol, 2-methyl-1-butanol, neopentyl alcohol, 2-pentanol, 3-methyl-2-butanol, 3-pentanol, and tert-amyl alcohol. In one or more embodiments, the C₂-C₅ acid ester is, for example, isobutyl isobutyrate, isoamyl isobutyrate, isoamyl isovalerate, isobutyl isovalerate, isoamyl acetate, ethyl acetate, and allyl acetate, among others. Particularly preferred acid esters include isobutyl isobutyrate and isobutyl isovalerate.

In one or more embodiments, the aldehyde is a C₂-C₈ aldehyde. In one or more embodiments, the C₂-C₈ aldehyde comprises at least one of propionaldehyde, isovaleraldehyde, or benzaldehyde. A particularly preferred aldehyde is benzaldehyde.

According to embodiments of the present disclosure, the propanoic acid, acid ester, acid salt, and aldehyde are provided in a ratio of about 2:2:5:2 (v/v/w/v). In one or more embodiments, propanoic acid is used in substantially equal volumes to the total acid ester component and to the total aldehyde component. In one or more embodiments, the propanoic acid, the acid ester, and the aldehyde comprise from 90% to 100% by volume of a liquid component of the composition. In one or more embodiments, each of the propanoic acid, the acid ester, and the aldehyde comprise 30% to 40% by volume of the composition, in particular 30% to 35% by volume.

In one or more embodiments, the composition may further comprise another acid component in addition to the propanoic acid. Examples of such acids include acetic acid, isobutyric acid, and citric acid.

In one or more embodiments, the acid salt comprises from 40% to 50% by weight of the composition, in particular 42% to 48% by weight. In one or more embodiments, each of the propanoic acid, the acid ester, and the aldehyde comprise from 10% to 25% by weight, in particular 15% to 20% by weight, of the composition. In this way, the acid salt comprises the major component of the composition. Advantageously, acid salt is biologically active and serves as a buffer to reduce any low pH effect that the acid may have on a treated agricultural product, such as fruits and vegetables.

In one or more embodiments, the composition is diluted in water to provide a nematicidal treatment for plants and/or their surrounding soil. In one or more embodiments, the treatment is diluted to a 0.1% to 2% solution, in particular, a 0.1% to 1% solution.

As mentioned above, a particularly preferred composition according to the present disclosure comprises propanoic acid, isobutyl isobutyrate, potassium isobutyrate, and benzaldehyde at 2:2:5:2 (v/v/w/v). Quite surprisingly and totally unexpectedly, when this composition was tested against plant parasitic nematodes held in suspension, the Applicant noted that the nematodes immediately became paralyzed and immobile. Their food reserve was rapidly depleted (in particular in less than 24 hours), and the nematodes eventually died.

In one or more embodiments, a plant or its surrounding soil treated with a composition according to the present disclosure will experience a nematode mortality after 24 hours of at least 90%, at least 95%, or at least 97%. In one or more embodiments, nematode mortality may be up to 100% after 24 hours.

### Experimental Embodiments

In the following discussion of the experimental embodiments, the nematicidal treatment is based on the use of a 1% solution of a composition (Composition A) of propanoic acid, isobutyl isobutyrate, potassium isobutyrate, and benzaldehyde at 2:2:5:2 v/v/w/v. Batches of the treatment comprising Composition A were made freshly on a regular basis and diluted accordingly as shown in the tables, graphs, and descriptions below.

The nematicidal effect of Composition A was measured against the root knot nematode, Meloidogyne sp. This nematode was selected because of its extreme importance to a wide diversity of applications in crop agriculture. In vitro effect of various concentrations of Composition A on Meloidogyne motility was studied in an aqueous assay under lab conditions.

Second stage juveniles (J2s) of root knot nematodes were extracted from tomato roots using a mist chamber and kept in a refrigerator at 7° C. until use. Nematodes were exposed to five treatments of increasing concentrations of Composition A in a total volume of 70-ml solution. The concentrations of Composition A increased from 0%, 0.125%, 0.25%, 0.5% and 1% of the nematicidal treatment. After exposure, nematode mortality was evaluated at 20 minutes, 1 hour, 4 hours, 6 hours, 24 hours, and 30 hours. At each time point, nematode motility (characterized as one of normal motility, affected motility, and immotile) was counted twice (1-ml per treatment under a light microscope at 4× magnification). To distinguish between live but immotile nematodes and dead nematodes at each time point, drops of 1 M NaOH were added to each counting slide, and the percentage of dead and alive of the same nematodes was recorded. The NaOH causes the live nematodes to display a rapid twisting movement and curling after a two minutes exposure, whereas the dead nematodes have no reaction. Probit analysis was used to calculate the lethal dose (LC50 and LC90).

To check if there was a nematicide or nematostatic effect of Composition A on root-knot nematodes, 200 J2s were taken from the stock solutions, transferred to a 20 μm sieve, and washed with tap water. Then, nematodes were inoculated into a pre-germinated cucumber seedling, in a 25-ml container, with four replicates per treatment. Cucumber seedlings were incubated under greenhouse conditions at 24±2° C. for four weeks. At the end of the fourth week, cucumber roots were washed out of soil, and root gall index (scale 0-10) was determined according to Zeck, W. M., “Rating scheme for field evaluation of root-knot nematode infestations,” Pflanzenschutz Nachr. 24:141-144 (1971).

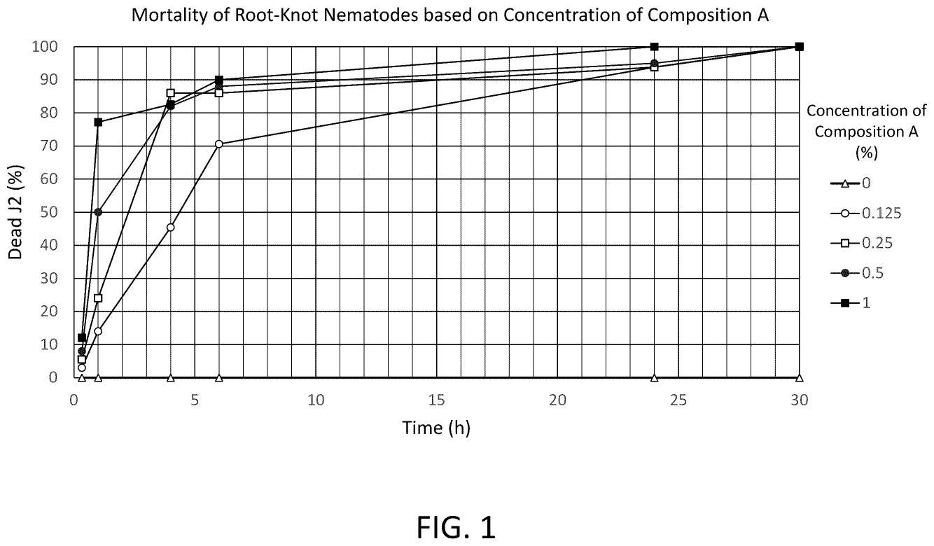

The in vitro effect of Composition A started to appear already at twenty minutes after nematodes were exposed to the different treatments. As shown in FIG. 1, the 0.125% solution of Composition A resulted in a 3% mortality rate after 20 minutes. The 0.25% solution resulted in a 5.5% mortality rate after 20 minutes. The 0.5% solution resulted in an 8% mortality rate after 20 minutes, and the 1% solution resulted in a 12.1% mortality rate after 20 minutes. After 1 hour, the 0.125% solution resulted in a 14% mortality rate, the 0.25% solution resulted in a 24% mortality rate, the 0.5% solution resulted in a 50% mortality rate, and the 1% solution resulted in a 77.2% mortality rate. After 4 hours, the 0.125% solution resulted in a 45.4% mortality rate, the 0.25% solution resulted in an 84% mortality rate, the 0.5% solution resulted in an 82% mortality rate, and the 1% solution resulted in an 82.6% mortality rate. After 6 hours, the 0.125% solution resulted in a 70.6% mortality rate, the 0.25% solution resulted in an 86% mortality rate, the 0.5% solution resulted in an 88% mortality rate, and the 1% solution resulted in a 90% mortality rate. After 24 hours, the 0.125% solution resulted in a 93.8% mortality rate, the 0.25% solution resulted in an 93.8% mortality rate, the 0.5% solution resulted in a 95% mortality rate, and the 1% solution resulted in a 100% mortality rate. After 30 hours, each of the 0.125% solution, the 0.25% solution, the 0.5% solution, and the 1% solution resulted in a 100% mortality rate.

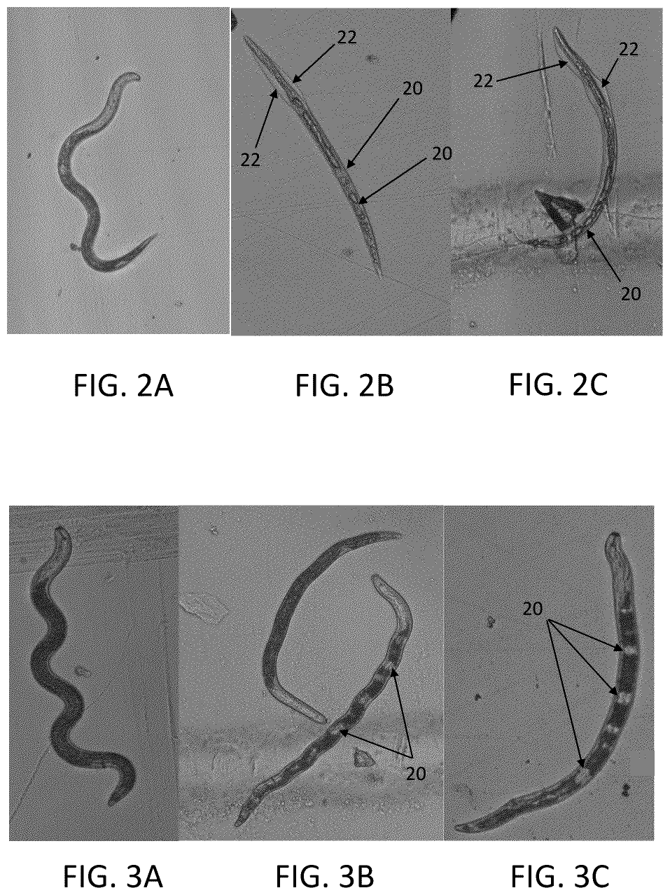

For the first 6 hours after exposure, increased nematicidal activity was observed with increased concentration, but after 24 hours of exposure, more than 90% mortality rate was recorded for all concentrations. As can be seen, the control treatment containing just water (i.e., 0% concentration of Composition A) did not exhibit any nematicidal activity. During observation of each sample, loss of integrity of the intestine and other organelles and cuticular deformities were observed. FIG. 2A depicts an example of a nematode after 30 hours of exposure to the water control. FIGS. 2B and 2C depict examples of nematodes after 24 hours of exposure to 1% solution of Composition A. The loss of integrity of the intestine and other organelles 20 and cuticular deformities 22 can be seen in FIGS. 2B and 2C when compared against the water control nematode shown in FIG. 2A.

Based on the mortality rate observed after NaOH exposure in the previous experiment, the lethal concentrations LC50 and LC90 for each time point were calculated using probit analysis and are provided below in Table 1.

TABLE 1
Lethal Concentration LC50 and LC90 of
Composition A on Root-Knot Nematodes

| | | |
|---|---|---|
| Time After Exposure | LC50 (50%) | LC90 (90%) |

| | | | |
|---|---|---|---|
| 20 | minutes | 2.8 | 9.2 |
| 1 | hour | 1.7 | 5.6 |
| 4 | hours | 0.5 | 1.7 |
| 6 | hours | 0.1 | 0.4 |
| 12 | hours | 0.1 | 0.2 |

Again, from Table 1, it can be seen that a longer exposure time requires a lesser concentration of Composition A for a high mortality rate. Indeed, for an exposure time of 12 hours, a concentration of only 0.2% would provide 90% mortality.

Table 2 shows the recorded nematode movement (characterized as one of normal motility, affected motility, and immotile) at each concentration and time point, followed by the observations after NaOH exposure (alive or dead), and recorded cucumber gall index (GI). The gall index represents the density of knots after second stage juveniles (J2s) penetrate the roots and develop into sedentary females. A higher gall index indicates that a higher number of J2s have successfully penetrated the plant and established a feeding site, corresponding to a higher damage level. The nematicide effect of Composition A against root-knot nematodes is clearly observed by the lower gall index at higher concentrations and higher treatment times. For all concentrations, the nematodes were dead after twenty-four hours, and root-knots on cucumber plants were not observed. As can be seen from Table 2, 97.5% or greater of the nematodes in all of the control samples were alive, and each exhibited a gall index of at least 5, demonstrating a significant difference between treated and untreated samples.

TABLE 2
Effect of Composition A at Different Concentrations
Over Time against Root-Knot Nematodes

| | | | Nematode movement | | | 1M NaOH | | Gall |
|---|---|---|---|---|---|---|---|---|
| Exposure | | Concentration | Normal | Affected | Immotile | Alive | Dead | Index |
| Time | | (%) | (%) | (%) | (%) | (%) | (%) | (GI) |
| 20 | min | 0 (control) | 90.5 | 4.5 | 0 | 99 | 1 | 5 c |
| 20 | min | 0.125 | 57.84 | 31.7 | 10.45 | 91.5 | 8.5 | 5 c |
| 20 | min | 0.25 | 37.2 | 48.6 | 14.2 | 94.5 | 5.5 | 5 c |
| 20 | min | 0.5 | 21 | 52 | 17 | 92 | 8 | 3.7 b |
| 20 | min | 1 | 8.9 | 66.4 | 24.7 | 87.9 | 12.1 | 3 b |
| 1 | hour | 0 | 91.3 | 8.7 | 0 | 97.5 | 2.5 | 5.75 c |
| 1 | hour | 0.125 | 0.87 | 28.45 | 70.68 | 86 | 14 | 4 bc |
| 1 | hour | 0.25 | 1.9 | 25.1 | 73 | 76 | 24 | 0.25 a |
| 1 | hour | 0.5 | 1.9 | 26.1 | 72 | 50 | 50 | 1.67 ab |
| 1 | hour | 1 | 0 | 18 | 82 | 22.8 | 77.2 | 1 ab |
| 4 | hours | 0 | 93.7 | 6.3 | 0 | 100 | 1.2 | 5.25 bc |
| 4 | hours | 0.125 | 0 | 41.1 | 58.9 | 54.6 | 45.4 | 4 bc |
| 4 | hours | 0.25 | 0 | 20.2 | 79.8 | 16 | 84 | 3.75 b |
| 4 | hours | 0.5 | 0 | 16.4 | 83.6 | 18 | 82 | 0.66 a |
| 4 | hours | 1 | 0 | 10.1 | 89.9 | 17.4 | 82.6 | 0.2 a |
| 6 | hours | 0 | 92.8 | 7.2 | 0 | 100 | 1.2 | 5 bc |
| 6 | hours | 0.125 | 0 | 27.4 | 72.6 | 29.4 | 70.6 | 3.5 b |
| 6 | hours | 0.25 | 0 | 13.4 | 86.6 | 14 | 86 | 3.5 b |
| 6 | hours | 0.5 | 0 | 10 | 90 | 12 | 88 | 0.33 a |
| 6 | hours | 1 | 0 | 6.3 | 93.7 | 10 | 90 | 0 a |
| 24 | hours | 0 | 89.7 | 7.6 | 2.7 | 98 | 2 | 5 c |
| 24 | hours | 0.125 | 0 | 2.2 | 97.8 | 6.2 | 93.8 | 0 a |
| 24 | hours | 0.25 | 0 | 4.2 | 95.8 | 6.2 | 93.8 | 0 a |
| 24 | hours | 0.5 | 0 | 3 | 97 | 5 | 95 | 0 a |
| 24 | hours | 1 | 0 | 0 | 100 | 0 | 100 | 0 a |
| 30 | hours | 0 | 90.4 | 6.4 | 3.2 | 98 | 2 | 5.25 c |
| 30 | hours | 0.125 | 0 | 0 | 100 | 0 | 100 | 0 a |
| 30 | hours | 0.25 | 0 | 0 | 100 | 0 | 100 | 0 a |
| 30 | hours | 0.5 | 0 | 0 | 100 | 0 | 100 | 0 a |
| 30 | hours | 1 | 0 | 0 | 100 | 0 | 100 | 0 a |

*Different letters (a, ab, b, bc, c) show statistical differences among treatments at α = 0.05 (anova, p-value < .001)

To confirm the nematicide effect of Composition A against root-knot nematodes, an in vivo assay under greenhouse conditions was established. In the in vivo assay, 750 nematodes were inoculated into small pots (247 ml) containing 260 g of a 1:1 mixture of loamy field soil to sand soil. Treatments consisted of five concentrations of Composition A (0%, 0.125%, 0.25%, 0.5%, and 1%) and an uninoculated control. A treatment of ten milliliters of each concentration was added into respective pots each day for two days after nematode inoculation. On the third day after nematode inoculation, a two-weeks old cucumber seedling was added into each pot. Treatments were replicated four times. The nematicide effect of Composition A was recorded by calculating the cucumber gall index (GI) and root length. Gall index showed statistical differences among treatments (anova, p-value <0.0001). Treatments also had a statistically different effect on root length (anova, p-value=0.0008). No differences between root length and gall index were observed between 1% Composition A and the uninoculated control (nematode free). Similarly, Composition A at 1%, 0.5% and 0.25% showed statistically similar effect on root length and gall index.

TABLE 3
In vivo Effect of Composition A on Root-Knot Nematodes

| Concentration | Root Length | GI |
|---|---|---|
| 0 | 11.75 b | 5.5 d |
| 0.125 | 11.25 b | 4.25 cd |
| 0.25 | 14.75 ab | 3.5 bd |
| 0.5 | 15 ab | 3.25 bc |
| 1 | 23.5 a | 2.33 ab |
| Uninoculated control | 23.5 a | 0 a |

*Different letters (a, ab, b, bc, c, cd, d) indicate statistical differences according to one-way anova with post-hoc Tukey HSD test at α < 0.05 (n = 4).

An in vitro assay was prepared to determine the nematicide effect of Composition A on root-lesion nematodes (RLN), Pratylenchus sp. The assay was conducted by counting nematode motility (characterized as one of normal motility, affected motility, and immotile) at six time points (20 min, 1 hour, 4 hours, 6 hours, 24 hours, and 30 hours) after exposure to the different concentrations of Composition A in solution (0%, 0.125%, 0.25%, 0.5%, and 1%), followed by the NaOH treatment as previously described. FIGS. 3A-3C shows the nematode appearance after 4 hours of exposure to the water control (FIG. 3A) and to a 0.5% solution of Composition A (FIGS. 3B and 3C). From a comparison of FIG. 3A and FIGS. 3B and 3C, the nematodes shown in FIGS. 3B and 3C exhibited loss of integrity of intestine and other organelles 20 and muscular paralysis as a result of treatment with Composition A.

Nematode movement was affected over time and with the increase of concentration (anova, p-value <0.001). At 4 hours after nematode exposure to the treatments, nematodes were meanly affected or dead (Table 4). At 6 hours and 24 hours after nematode exposure, affected nematode specimens were not responding to NaOH treatment. To conclude if nematodes were dead or alive, affected specimens (untreated with NaOH) were transferred into well plates containing tap water to observe any recovery. The nematodes did not recover movement after being touched with a needle or after being in water for another 24 hours. The Applicant concluded that nematodes were dead within 24 hours of exposure to all concentrations of Composition A (except for the 0% water control).

TABLE 4
Effect of Composition A against Root
Lesion Nematodes, Pratylenchus sp.

| | | Concen- | Nematode movement | | | 1M NaOH | |
|---|---|---|---|---|---|---|---|
| Exposure | | tration | Normal | Affected | Immotile | Alive | Dead |
| Time | | (%) | (%) | (%) | (%) | (%) | (%) |
| 20 | min | 0 (control) | 96.2 | 1.2 | 2.6 | 98.5 | 1.5 |
| 20 | min | 0.125 | 65.9 | 4.9 | 29.2 | 93.3 | 6.7 |
| 20 | min | 0.25 | 77 | 14.7 | 8.3 | 97.5 | 2.5 |
| 20 | min | 0.5 | 55.9 | 32.7 | 11.4 | 94.3 | 5.7 |
| 20 | min | 1 | 52 | 38.2 | 9.8 | 87.2 | 12.8 |
| 1 | hour | 0 | 94.7 | 2.2 | 3.1 | 96.3 | 3.7 |
| 1 | hour | 0.125 | 24.3 | 52 | 23.7 | 94.3 | 5.7 |
| 1 | hour | 0.25 | 26 | 49.5 | 24.5 | 95.2 | 4.8 |
| 1 | hour | 0.5 | 36.9 | 51.9 | 11.2 | 95 | 5 |
| 1 | hour | 1 | 18 | 40 | 41 | 87.7 | 12.3 |
| 4 | hours | 0 | 95.3 | 2 | 2.7 | 96.4 | 4.6 |
| 4 | hours | 0.125 | 0.8 | 54.4 | 44.8 | 90.2 | 9.8 |
| 4 | hours | 0.25 | 0 | 69.1 | 30.9 | 89.1 | 10.9 |
| 4 | hours | 0.5 | 0 | 73.7 | 26.3 | 89.3 | 10.7 |
| 4 | hours | 1 | 0 | 84 | 16 | 51.7 | 48.3 |
| 6 | hours | 0 | 94 | 1.3 | 4.7 | 97.2 | 2.8 |
| 6 | hours | 0.125 | 0 | 85.2 | 14.8 | 91.6 | 8.4 |
| 6 | hours | 0.25 | 0 | 83.7 | 16.3 | 98.5 | 10.5 |
| 6 | hours | 0.5 | 0 | 86.3 | 13.7 | 59 | 41 |
| 6 | hours | 1 | 0 | 73.4 | 26.6 | 39 | 61 |
| 24 | hours | 0 | 100 | 2.2 | 2.2 | 96.1 | 3.9 |
| 24 | hours | 0.125 | 0 | 32 | 68 | 31.8 | 68.2 |
| 24 | hours | 0.25 | 0 | 14.1 | 85.69 | 18.5 | 81.5 |
| 24 | hours | 0.5 | 0 | 1.9 | 98.1 | 9 | 91 |
| 24 | hours | 1 | 0 | 2.2 | 97.8 | 0 | 100 |

To test the effect of Composition A against root lesion nematodes in soil, small cones were filled with 65 g of a soil mixture containing 1:1 field soil to sand, and approximately 260 P. neglectus (equivalent to 4.000 RLN/kg soil) were inoculated in two holes (3 cm deep) and left overnight. In the following morning, each cone received 3 ml of the respective treatment (Composition A at 0% (water control), 0.125%, 0.25%, 0.5%, 1%). Two days after nematode inoculation (one day post-treatment), one pre-germinated winter wheat seedling cv. Judee (susceptible cultivar) was added into each cone. Treatments were incubated at 23±2° C. for 10 days. After incubation time, roots were washed out of soil, and nematode number was estimated. Nematodes were extracted from soil using a modified Baermann tray for 48 hours, while nematodes inside the roots were visualized by root staining using the acid fuchsin method. The total number of root lesion nematodes per root system was counted.

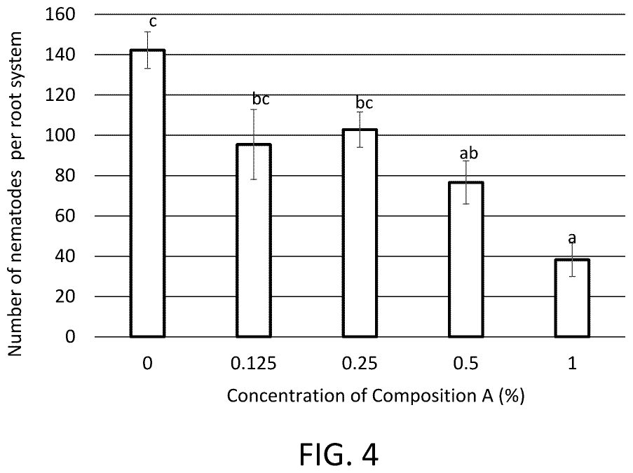

Table 5 and FIG. 4 show the total number of root lesion nematodes recovered per cone (nematodes per root system) after 260 root lesion nematodes were inoculated in the soil, followed by a single dose of 3 ml solution of each treatment. Treatments showed statistical differences in nematode mortality (observed as number of nematodes per root system) (anova, p-value <0.0001). Higher nematode mortality was observed at concentrations of 0.5% and 1% Composition A, and these treatments were not statistically different (p-value=0.159). Treatments at 0.125% and 0.25% did not differ from the untreated control at (α=0.05; p-value=0.14226 and p-value=0.05872, respectively). Based on the foregoing it was observed that a single 3 ml application of 1% Composition A on small cones containing field soil reduced nematode invasion by approximately 70% when compared with water control.

TABLE 5
Effect of Composition A Concentrations
on Root Lesion Nematodes

| Composition A | Root lesion nematodes recovered per |
|---|---|
| Concentration (%) | root system (±standard error) |
| 0 (water control) | 142.2 ± 9.1 c |
| 0.125 | 95.4 ± 17.4 bc |
| 0.25 | 102.8 ± 8.8 bc |
| 0.5 | 76.6 ± 10.7 ab |
| 1 | 38.2 ± 8.3 a |

Different letters (a, ab, bc, c) indicate statistical differences according to one-way anova with post-hoc Tukey HSD test at α < 0.05 (n = 5).

The effect of Composition A at a concentration of 0.5% was tested against nematodes belonging to the Criconematidea family (ring nematodes), dagger nematodes (Xiphinema spp.), spiral nematodes (Helicotylenchus spp.), stem and bulb nematodes (Ditylenchus spp.), pin nematodes (Pratylenchus spp.), and stunt nematodes (Tylenchorhynchus spp.). Nematodes were extracted from a garden soil sample or greenhouse culture using the modified Baermann tray, hand-picked with the help of a picking needle, and transferred to a well in a 24-well plate containing 1 ml of 0.5% Composition A. Two nematodes of the same genera were provided in each well, and testing was replicated four times. Water was used as a control. Nematode movement was determined 6 hours and 24 hours after exposure by gentle touching with the picking needle. Because of the limited number of specimens, nematodes were not exposed to NaOH treatment, and instead, after the 24 hours of exposure time, nematodes were individually transferred to water solution to confirm nematode mortality.

Table 6 shows the mortality rate of the tested genera at 6 hours and 24 hours after exposure. More than 50% of the tested specimens did not respond when gently touched by the picking needle 6 hours after exposure to 0.5% concentration of Composition A. They also did not recover movement over 24 hours after being transferred to water and therefore were considered dead.

TABLE 6
Mortality Rate of Tested Plant-Parasitic Nematodes

| Nematode | Time after exposure | | Dead specimens (%) |
|---|---|---|---|
| Criconematidea | 6 | hours | 75% |
| (Ring Nematode) | 24 | hours | 100% |
| Xiphinema spp. | 6 | hours | 75% |
| (Dagger nematode) | 24 | hours | 100% |
| Helicotylenchus spp. | 6 | hours | 90% |
| (Spiral Nematode) | 24 | hours | 100% |
| Ditylenchus spp. | 6 | hours | 75% |
| (stem and bulb nematodes) | 24 | hours | 100% |
| Paratylenchus spp. | 6 | hours | 88% |
| (Pin Nematode) | 24 | hours | 100% |
| Tylenchorhynchus spp. | 6 | hours | 90% |
| (Stunt nematode) | 24 | hours | 100% |

Based on the foregoing, a composition effective at treating plant parasitic nematodes is provided. In particular, the composition at various concentrations has the ability to paralyze or reduce the movement of nematodes in as little as 20 minutes in aqueous solution, suggesting that it possesses antinematode activity. At longer exposure times of 24 to 30 hours, the composition at concentrations as low as 0.125%, was able to completely kill certain nematodes, including root-knot nematode. The composition also demonstrated a wide range of nematicidal activity against a variety of plant parasitic nematodes including the root lesion nematode Pratylenchus sp. The composition showed nematicidal effect against plant-parasitic nematodes in not only aqueous solution but also in nematode-infested soils. Advantageously, the composition did not cause any observable negative effects on the plants that were treated with it at the concentrations used. Further, as compared to currently available nematicides, the compositions disclosed herein are significantly less harmful to the environment while also being significantly more effective.

In one or more embodiments, the compositions described herein are envisioned to be GRAS (“generally recognized as safe”), and in certain embodiments, it is envisioned that compositions described may be able to be labeled as organic.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A composition, comprising:
propanoic acid;
a salt of a C₄-C₆ acid;
an acid ester having a C₂-C₅ carboxylic acid moiety and a C₂-C₅ alcohol moiety; and
a C₂-C₈ aldehyde;
wherein a ratio of the propanoic acid to the salt to the acid ester to the C₂-C₈ aldehyde is 2:2:5:2 (v/v/w/v).

2. The composition of claim 1, wherein the C₄-C₆ acid of the salt comprises a C₄ acid.

3. The composition of claim 2, wherein the C₄ acid is isobutyric acid.

4. The composition of claim 1, wherein the salt is a potassium, sodium, or ammonium salt.

5. The composition of claim 1, wherein the C₂-C₅ carboxylic acid moiety comprises at least one of acetic acid, propanoic acid, butyric acid, isobutyric acid, valeric acid, or isovaleric acid.

6. The composition of claim 1, wherein the C₂-C₅ alcohol moiety comprises at least one of ethanol, propanol, allyl alcohol, isopropanol, butanol, isobutanol, sec-butanol, tert-butanol, pentanol, isoamyl alcohol, 2-methyl-1-butanol, neopentyl alcohol, 2-pentanol, 3-methyl-2-butanol, 3-pentanol, or tert-amyl alcohol.

7. The composition of claim 1, wherein the acid ester comprises at least one of isobutyl isobutyrate, isoamyl isobutyrate, isoamyl isovalerate, isobutyl isovalerate, isoamyl acetate, ethyl acetate, or allyl acetate.

8. The composition of claim 1, wherein the C₂-C₈ aldehyde comprises at least one of propionaldehyde, isovaleraldehyde, or benzaldehyde.

9. A nematicidal solution, comprising the composition according to claim 1 diluted with water.

10. The nematicidal solution of claim 9, comprising a concentration of 0.1% to 2% of the composition.

11. A nematicidal composition, comprising:
a liquid component comprising propanoic acid, at least one acid ester, and at least one aldehyde, wherein the propanoic acid, the at least one acid ester, and the at least one aldehyde comprise from 90% to 100% by volume of the liquid component; and
an acid salt dissolved in the liquid component.

12. The nematicidal composition of claim 11, wherein each of the propanoic acid, the at least one acid ester, and the at least one aldehyde comprises from 30% to 40% by volume of the liquid component.

13. The nematicidal composition of claim 11, wherein the acid salt comprises from 40% to 50% by weight of the nematicidal composition.

14. The nematicidal composition of claim 11, wherein each of the propanoic acid, the at least one acid ester, and the at least one aldehyde comprise from 10% to 25% by weight of the nematicidal composition.

15. The nematicidal composition of claim 11, wherein the at least one acid ester consists of acid esters having a C₂-C₅ carboxylic acid moiety and a C₂-C₅ alcohol moiety.

16. The nematicidal composition of claim 11, wherein the at least one acid salt consists of salts of C₄-C₆ acids.

17. The nematicidal composition of claim 11, wherein the at least one acid salt consists of salts of potassium, sodium, or ammonium.

18. The nematicidal composition of claim 11, wherein the at least one aldehyde consists of C₂-C₈ aldehydes.

19. A nematicidal solution comprising the nematicidal composition of claim 11 diluted with water.

20. The nematicidal solution of claim 19, comprising a concentration of the nematicidal composition of 0.1% to 2%.

21. A method of treating plant parasitic nematodes, comprising:
applying a solution comprising a composition to soil surrounding a plant, wherein the composition comprises propanoic acid, a salt of a C₄-C₆ acid, an acid ester having a C₂-C₅ carboxylic acid moiety and a C₂-C₅ alcohol moiety, and a C₂-C₈ aldehyde;
wherein a ratio of the propanoic acid to the salt to the acid ester to the C₂-C₈ aldehyde is 2:2:5:2 (v/v/w/v).

22. The method of claim 21, wherein the solution has a concentration of the composition of 0.1% to 2%.

23. The method of claim 21, wherein the solution comprises the composition diluted with water.

24. The method of claim 21, wherein the C₄-C₆ acid of the salt comprises a C₄ acid.

25. The method of claim 24, wherein the C₄ acid is isobutyric acid.

26. The method of claim 21, wherein the salt is a potassium, sodium, or ammonium salt.

27. The method of claim 21, wherein the C₂-C₅ carboxylic acid moiety comprises at least one of acetic acid, propanoic acid, butyric acid, isobutyric acid, valeric acid, or isovaleric acid.

28. The method of claim 21, wherein the C₂-C₅ alcohol moiety comprises at least one of ethanol, propanol, allyl alcohol, isopropanol, butanol, isobutanol, sec-butanol, tert-butanol, pentanol, isoamyl alcohol, 2-methyl-1-butanol, neopentyl alcohol, 2-pentanol, 3-methyl-2-butanol, 3-pentanol, or tert-amyl alcohol.

29. The method of claim 21, wherein the acid ester comprises at least one of isobutyl isobutyrate, isoamyl isobutyrate, isoamyl isovalerate, isobutyl isovalerate, isoamyl acetate, ethyl acetate, or allyl acetate.

30. The method of claim 21, wherein the C₂-C₈ aldehyde comprises at least one of propionaldehyde, isovaleraldehyde, or benzaldehyde.

31. The method of claim 21, wherein applying the solution further comprises applying at least 5 ml of the solution to the plant or to the soil surrounding the plant.

32. The method of claim 21, wherein thirty hours after applying at least 90% of the parasitic nematodes are dead.

33. The method of claim 21, wherein the parasitic nematodes comprise at least one of Meloidogyne sp., Pratylenchus sp., P. neglectus, a nematode of Criconematidea family, Xiphinema spp., Helicotylenchus spp., Ditylenchus spp., or Tylenchorhynchus spp.
